(19) United States
(12) Patent Application Publication
(10) Pub. No.: US 2010/0037716 A1
(43) Pub. Date: Feb. 18, 2010

(54) Clampless adjustable polish rod and well drilling equipment comprising same

(76) Inventor: John Rolan, Hobbs, NM (US)

Correspondence Address: JOHN ROLAN, 720 GREEN ACRES, HOBBS, NM, 88240, US

(21) Appl. No.: 12/462,271

(22) Filed: Jul. 31, 2009

Related U.S. Application Data
(60) Provisional application No. 61/189,390, filed on Aug. 18, 2008.

(51) Int. Cl. F16H 21/32; F16C 7/00; E21B 43/00; F04B 47/02; E21B 43/12

(52) U.S. Cl. 74/41; 74/579 R; 166/379

(57) ABSTRACT

A polish rod apparatus connectable between a motion imparting mechanism of a pump jack and a string of sucker rods comprises a polish rod and a lift device. The polish rod has a center portion extending between its first end portion and second end portion. The center portion includes a thread structure extending along a portion of its length. The first end portion is connectable to the string of sucker rods. The lift device has an adjuster body including a central passage extending therethrough. The central passage of the adjuster body includes a thread structure matingly engagable with the thread structure of the polish rod such that rotation of the adjuster body relative to the polish rod causes axial movement of the adjuster body along a longitudinal axis of the polish rod thereby enabling vertical adjustment of the sucker rod assembly with respect to the motion imparting mechanism.

### CROSS REFERENCE TO RELATED APPLICATIONS

This patent application claims priority from co-pending U.S. Provisional Patent Application having Ser. No. 61/189,390 filed Aug. 18, 2008, entitled “Rolan's Clampless Adjustable Polish Rod”, having a common applicant herewith and being incorporated herein in its entirety by reference.

### FIELD OF THE DISCLOSURE

The disclosures made herein relate generally to oil field equipment and, more particularly, to a pump jack for reciprocating an oil well pump and to devices configured for allowing adjustability of a polish rod of a pump jack.

### BACKGROUND

Pump jacks, which are also known as beam pumping units, are used for driving reciprocating pumps located downhole in the bore of a subterranean oil wellhead. With respect to a typical arrangement of a pump jack, a string of sucker rods is suspended from a carrier bar of the pump jack.

A polish rod is provided at the top of the string of sucker rods and is connected to the carrier bar. The carrier bar is suspended from the horsehead of the pump jack by a cable bridle. The polish rod is suspended by a polish rod clamp atop the carrier bar or rod-rotator. The polish rod extends through the carrier bar and downwardly through a stuffing box seal at a wellhead. The polish rod is connected to the string of sucker rods and the string of sucker rods extends downhole to a pump within a well-bore casing.

The use of a clamp is a conventional approach for securing the polish rod to the carrier bar in a fixed location with respect to the carrier bar. A conventional polish rod has a substantially smooth exterior surface (e.g., a smooth rod made of steel) and the clamp compressively bears on the exterior surface such that relative movement of the clamp with respect to the polish rod is precluded. Loosening of the clamp allows for vertical adjustment of the polish rod and, thus, the string of sucker rods with respect to the carrier bar. One drawback of such clamp arrangement is that it is difficult to controllably make desired adjustments (e.g., especially small precise adjustments) of the polish rod with respect to the carrier bar.

Therefore, an arrangement for securing the polish rod in a fixed vertical position with respect to the carrier bar while providing for controlled vertical adjustment of the polish rod with respect to the carrier bar would be advantageous, desirable and useful.

### SUMMARY OF THE DISCLOSURE

Embodiments of the present invention provide an arrangement for securing the polish rod in a fixed vertical position with respect to the carrier bar. More specifically, embodiments of the present invention provide for controlled vertical adjustment of the polish rod with respect to the carrier bar. In doing so, embodiments of the present invention advantageously overcomes one or more shortcomings associated with conventional approaches for securing a polish rod in a fixed position with respect to a carrier bar.

In one embodiment of the present invention, a polish rod apparatus of a pump jack system is adapted for being connected between a motion imparting mechanism of a pump jack and a string of sucker rods. The polish rod apparatus comprises a polish rod and a lift device. The polish rod has a first end portion, a second end portion and a center portion extending between the first and second end portions. The center portion includes a thread structure extending along at least a portion of a length thereof. The first end portion is configured for being connected to the string of sucker rods. The lift device has an adjuster body including a central passage extending therethrough. The central passage of the adjuster body includes a thread structure configured for being matingly engaged with the thread structure of the polish rod such that rotation of the adjuster body relative to the polish rod causes axial movement of the adjuster body along a longitudinal axis of the polish rod thereby enabling vertical adjustment of the sucker rod assembly with respect to the motion imparting mechanism.

In another embodiment of the present invention, a pump jack is configured for driving a pump unit of a subterranean well. The pump jack comprises a sucker rod assembly, a motion imparting mechanism, a polish rod and a lift device. The sucker rod assembly includes a string of sucker rods and a polish rod attachment structure attached to the string of sucker rods. The motion imparting mechanism includes a lift device engaging structure operable to move in opposing vertical directions with respect to a wellhead of the subterranean well. The polish rod has a first end portion, a second end portion and a center portion extending between the first and second end portions. The first end portion of the polish rod is engaged with the polish rod attachment structure of the sucker rod assembly. The center portion includes a thread structure extending along at least a portion of a length thereof. The lift device is coupled between the polish rod and the lift device engaging structure of the motion imparting mechanism. The lift device includes an adjuster body having a central passage extending therethrough. The polish rod extends through the central passage of the adjuster body. The adjuster body includes a thread structure within the central passage thereof threadedly engaged with the thread structure of the polish rod such that rotation of the adjuster body relative to the polish rod causes axial movement of the adjuster body along a longitudinal axis of the polish rod thereby causing vertical adjustment of the sucker rod assembly with respect to the motion imparting mechanism.

In another embodiment of the present invention, a method is configured for adjustably driving a pump unit of a subterranean well. The method comprises a plurality of operations. Operations are performed for disposing a string of sucker rods within a well bore casing of the subterranean well and for attaching an end portion of a polish rod to a polish rod attachment structure of the string of sucker rods. An operation is performed for extending the polish rod through a lift device engaging structure of a motion imparting mechanism from a first side thereof. The motion imparting mechanism includes an apparatus operable to move the lift device engaging structure in opposing vertical directions with respect to a wellhead of the subterranean well. An operation is performed for threadedly engaging a thread structure within a central passage of a lift device with a mating threaded structure of an exterior surface of the polish rod such that the polish rod extends through the central passage and the lift device is coupled between the polish rod and a second side of the lift device engaging structure. Thereafter, an operation is performed for rotating the lift device relative to the polish rod such that rotation of the lift device causes axial movement of the lift device along a longitudinal axis of the polish rod thereby causing vertical adjustment of the string of sucker rods with respect to the lift device engaging structure of the motion imparting mechanism.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 is a front view showing a pump jack including a polish rod apparatus configured in accordance with an embodiment of the present invention.

FIG. 2 is a side view of the showing a pump jack and polish rod apparatus of FIG. 1.

FIG. 3 is an enlarged view of the polish rod apparatus of FIG. 1.

FIG. 4 is a cross sectional view taken along the line 4-4 in FIG. 3.

### DETAILED DESCRIPTION OF THE DRAWING FIGURES

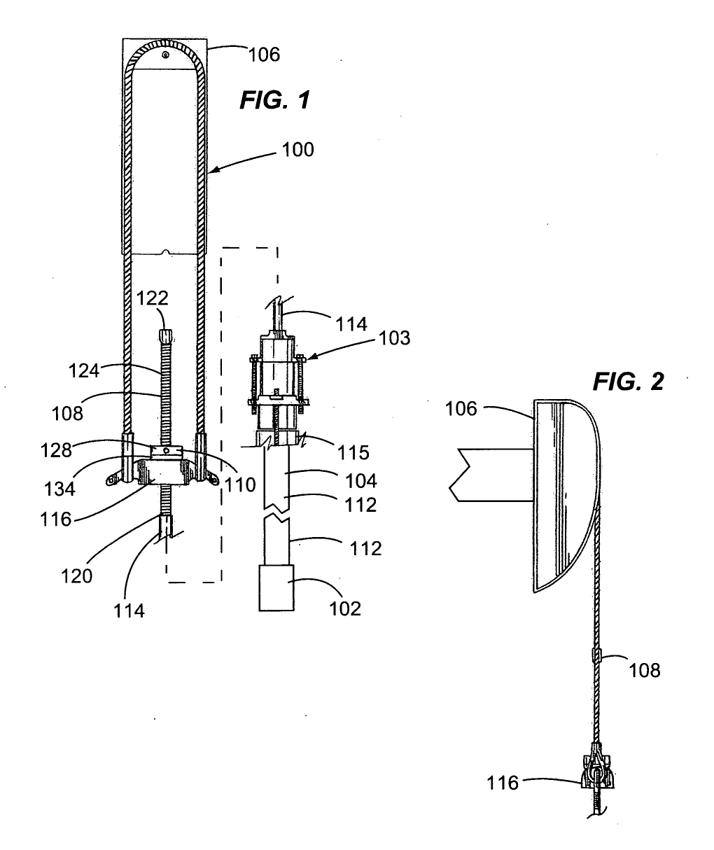

Referring to FIGS. 1 and 2, a pump jack 100 is configured for driving a pump unit 102 of a subterranean well 103. The pump jack 100 comprises a sucker rod assembly 104, a motion imparting mechanism 106, a polish rod 108 and a lift device 110. The sucker rod assembly 104 includes a string of sucker rods 112 and a polish rod attachment structure 114 attached to the string of sucker rods 112. The string of sucker rods 112 extends through a well bore casing 115. The motion imparting mechanism 106 includes a lift device engaging structure 116 (e.g., a carrier bar) operable to move in opposing vertical directions with respect to a wellhead 118 of the subterranean well.

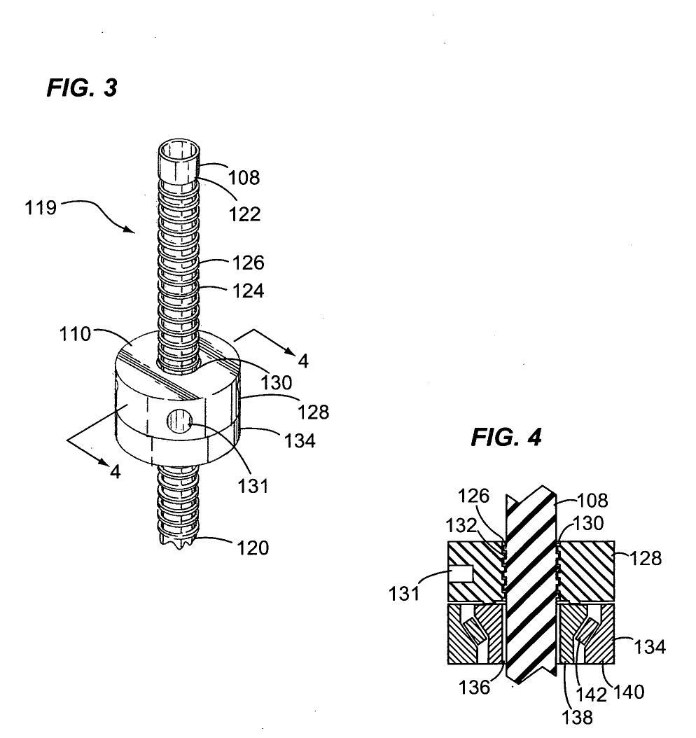

Referring now to FIGS. 1-4, a polish rod apparatus 119 comprises the polish rod 108 and the lift device 110. The polish rod 108 has a first end portion 120, a second end portion 122 and a center portion 124. The center portion 124 extends between the first end portion 120 and second end portion 122. The first end portion 120 of the polish rod 108 is engaged with the polish rod attachment structure 114 of the sucker rod assembly 104. For example, in one embodiment, the first end portion 120 of the polish rod 108 is threadedly engaged with the polish rod attachment structure 114 of the sucker rod assembly 104. The center portion 124 includes helical threads 126 (i.e., a thread structure) extending along all or a portion of its length. Preferably, but not necessarily, the helical threads 126 of the polish rod 128 extend along substantially an entire length of the center portion 124 of the polish rod 108.

The lift device 110 is coupled between the polish rod 108 and the lift device engaging structure 116. The lift device 110 includes an adjuster body 128 having a central passage 130 extending therethrough. The adjuster body 128 includes one or more adjustment wrench engaging features 131 (e.g., holes) on its exterior surface. The polish rod 108 extends through the central passage 130 of the adjuster body 128. The adjuster body 128 includes helical threads 132 thread structure within the central passage 130 threadedly engaged with the helical threads 126 of the polish rod 108. In this manner, rotation of the adjuster body 128 relative to the polish rod 108 causes axial movement of the adjuster body 128 along a longitudinal axis of the polish rod 108 thereby causing vertical adjustment of the sucker rod assembly 104 with respect to the motion imparting mechanism 106. Such vertical adjustment enables a rod pump (e.g., the pump unit 102) to be spaced out properly.

It is disclosed herein that the polish rod 108 can be a multi-piece rod. In one embodiment, a first piece is threaded and a second pieces attached to the first piece is not threaded. The first and second pieces can be fixedly attached to each other or one piece can rotate relative to the other.

As shown in FIGS. 1, 3 and 4, the lift device 110 includes a bearing unit 134 integral therewith. The bearing unit 134 has a central passage 136, which is preferably generally aligned in a concentric orientation with respect to the central passage 130 of the adjuster body 128. The polish rod 108 extends through the central passage 136 of the bearing unit 134 as well as the central passage 130 of the adjuster body 128. The bearing unit 134 is coupled between the adjuster body 128 and the lift device engaging structure 116. The bearing unit 124 is configured for carrying vertical loading exerted between the adjuster body and the motion imparting mechanism while simultaneously reducing resistive rotational force associated with rotation of the lift device relative to the polish rod while said vertical loading is exerted thereon. The bearing includes an inner race 138, an outer race 140 and a plurality of rollers 142 disposed between the races 138, 140. Loads are exerted between the races 138, 140 through the rollers 142. Furthermore, the rollers 142 allow for smooth rotational functionality of the inner race 138 relative to the outer race 140. It is disclosed herein that a bushing unit (i.e., a bushing made from a bronze material, Teflon or the like) can be used in place of or in combination with the bearing unit 134.

In operation, the string of sucker rods 112 is disposed within the well bore casing 115 of the subterranean well 103. The first end portion 120 of the polish rod 108 is attached to the polish rod attachment structure 114 of the string of sucker rods 112. The polish rod is extended through the lift device engaging structure 116 of the motion imparting mechanism 100 from its first side. The helical threads 132 within a central passage of the adjuster body 128 are threadedly engaged with the helical threads 126 of the polish rod 108 such that the polish rod 108 extends through the central passage 130 of the adjuster body 128 and the lift device 110 is coupled between the polish rod 108 and a second side of the lift device engaging structure 116. Thereafter, the lift device 110 is rotated relative to the polish rod 108 such that rotation of the lift device 110 causes axial movement of the lift device 110 along the longitudinal axis of the polish rod 108 thereby causing vertical adjustment of the string of sucker rods 112 with respect to the lift device engaging structure 116 of the motion imparting mechanism 100.

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A polish rod apparatus of a pump jack system, wherein the polish rod apparatus adapted for being connected between a motion imparting mechanism of a pump jack and a string of sucker rods, the polish rod apparatus comprising:
a polish rod having a first end portion, a second end portion and a center portion extending between said first and second end portions, wherein the center portion includes a thread structure extending along at least a portion of a length thereof and wherein the first end portion is configured for being connected to the string of sucker rods; and
a lift device having an adjuster body including a central passage extending therethrough, wherein the central passage of the adjuster body includes a thread structure configured for being matingly engaged with the thread structure of the polish rod such that rotation of the adjuster body relative to the polish rod causes axial movement of the adjuster body along a longitudinal axis of the polish rod thereby enabling vertical adjustment of the sucker rod assembly with respect to the motion imparting mechanism.

2. The polish rod apparatus of claim 1 wherein:
the lift device includes a bearing unit having a central passage configured for allowing the polish rod to extend therethrough;
the bearing unit is configured for carrying vertical loading exerted between the adjuster body and the motion imparting mechanism while simultaneously reducing resistive rotational force associated with rotation of the lift device relative to the polish rod while said vertical loading is exerted thereon.

3. The polish rod apparatus of claim 2 wherein the bearing unit includes a central passage generally aligned in a concentric orientation with respect to the central passage of the adjuster body.

4. The polish rod apparatus of claim 3 wherein the thread structure of the polish rod extends along substantially an entire length of the center portion.

5. The polish rod apparatus of claim 4 wherein adjuster body includes at least one adjustment wrench engaging features on an exterior surface thereof.

6. The polish rod apparatus of claim 1 wherein the bearing unit includes a central passage generally aligned in a concentric orientation with respect to the central passage of the adjuster body.

7. The polish rod apparatus of claim 1 wherein the thread structure of the polish rod extends along substantially an entire length of the center portion.

8. The polish rod apparatus of claim 1 wherein the adjuster body includes at least one adjustment wrench engaging features on an exterior surface thereof.

9. A pump jack configured for driving a pump unit of a subterranean well, comprising:
a sucker rod assembly including a string of sucker rods and a polish rod attachment structure attached to the string of sucker rods;
a motion imparting mechanism including a lift device engaging structure operable to move in opposing vertical directions with respect to a wellhead of the subterranean well;
a polish rod having a first end portion, a second end portion and a center portion extending between said first and second end portions, wherein the first end portion thereof is engaged with the polish rod attachment structure of the sucker rod assembly and wherein the center portion includes a thread structure extending along at least a portion of a length thereof; and
a lift device coupled between the polish rod and the lift device engaging structure of the motion imparting mechanism, wherein the lift device includes an adjuster body having a central passage extending therethrough, wherein the polish rod extends through the central passage of the adjuster body, wherein the adjuster body includes a thread structure within the central passage thereof threadedly engaged with the thread structure of the polish rod such that rotation of the adjuster body relative to the polish rod causes axial movement of the adjuster body along a longitudinal axis of the polish rod thereby causing vertical adjustment of the sucker rod assembly with respect to the motion imparting mechanism.

10. The pump jack of claim 9 wherein:
the lift device includes a bearing unit having a central passage with the polish rod extending therethrough;
the bearing unit is coupled between the adjuster body and the lift device engaging structure; and
the bearing unit is configured for carrying vertical loading exerted between the adjuster body and the motion imparting mechanism while simultaneously reducing resistive rotational force associated with rotation of the lift device relative to the polish rod while said vertical loading is exerted thereon.

11. The pump jack of claim 9 wherein the bearing unit includes a central passage generally aligned in a concentric orientation with respect to the central passage of the adjuster body.

12. The pump jack of claim 9 wherein the thread structure of the polish rod extends along substantially an entire length of the center portion.

13. The pump jack of claim 9 wherein the adjuster body includes at least one adjustment wrench engaging features on an exterior surface thereof.

14. The pump jack of claim 9 wherein:
the lift device includes a bearing unit having a central passage with the polish rod extending therethrough;
the bearing unit is coupled between the adjuster body and the lift device engaging structure;
the bearing unit is configured for carrying vertical loading exerted between the adjuster body and the motion imparting mechanism while simultaneously reducing resistive rotational force associated with rotation of the lift device relative to the polish rod while said vertical loading is exerted thereon;
the bearing unit includes a central passage generally aligned in a concentric orientation with respect to the central passage of the adjuster body;
the thread structure of the polish rod extends along substantially an entire length of the center portion; and
the adjuster body includes at least one adjustment wrench engaging features on an exterior surface thereof.

15. A method for adjustably driving a pump unit of a subterranean well, comprising:
disposing a string of sucker rods within a well bore casing of the subterranean well;
attaching an end portion of a polish rod to a polish rod attachment structure of the string of sucker rods,
extending the polish rod through a lift device engaging structure of a motion imparting mechanism from a first side thereof, wherein the motion imparting mechanism includes an apparatus operable to move the lift device engaging structure in opposing vertical directions with respect to a wellhead of the subterranean well;
threadedly engaging a thread structure within a central passage of a lift device with a mating threaded structure of an exterior surface of the polish rod such that the polish rod extends through the central passage and the lift device is coupled between the polish rod and a second side of the lift device engaging structure; and
rotating the lift device with respect to the polish rod such that rotation of the lift device causes axial movement of the lift device along a longitudinal axis of the polish rod thereby causing vertical adjustment of the string of sucker rods with respect to the lift device engaging structure of the motion imparting mechanism.

16. The method of claim 15 wherein:
the lift device includes a bearing unit having a central passage with the polish rod extending therethrough;
the bearing unit is coupled between the adjuster body and the lift device engaging structure; and
the bearing unit is configured for carrying vertical loading exerted between the adjuster body and the motion imparting mechanism while simultaneously reducing resistive rotational force associated with rotation of the lift device relative to the polish rod while said vertical loading is exerted thereon.

17. The method of claim 15 wherein the bearing unit includes a central passage generally aligned in a concentric orientation with respect to the central passage of the adjuster body.

18. The method of claim 15 wherein the thread structure of the polish rod extends along substantially an entire length of the center portion.

19. The method of claim 15 wherein the adjuster body includes at least one adjustment wrench engaging features on an exterior surface thereof.
